(19) United States
(12) Patent Application Publication
(10) Pub. No.: US 2024/0098205 A1
(43) Pub. Date: Mar. 21, 2024

(54) INFORMATION PROCESSING APPARATUS, INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Ami KANZAKI, Kanagawa (JP)

(73) Assignee: FUJIFILM Business Innovation Corp., Tokyo (JP)

(21) Appl. No.: 18/180,986

(22) Filed: Mar. 9, 2023

(30) Foreign Application Priority Data
Sep. 20, 2022 (JP) 2022-149538

(51) Int. Cl. H04N 1/34; H04N 1/00

(52) U.S. Cl. CPC H04N 1/342; H04N 1/00244

(57) ABSTRACT

An information processing apparatus includes a processor configured to: acquire a specification of print data and information to be used for printing the print data by each of multiple order receivers; and calculate a cost for placing an order for printing the print data for each order receiver based on the acquired specification of the print data and the acquired information and present the cost.

### CROSS-REFERENCE TO RELATED APPLICATIONS

This application is based on and claims priority under 35 USC 119 from Japanese Patent Application No. 2022-149538 filed Sep. 20, 2022.

### BACKGROUND

### (i) Technical Field

The present disclosure relates to information processing apparatuses, information processing systems, information processing methods, and non-transitory computer readable media.

### (ii) Related Art

Japanese Unexamined Patent Application Publication No. 2008-186165 proposes an electronic-document generating-distributing system that performs a process including: a step for generating a font-embedded PDF document from which a font is readily removable; a step for generating font-removal support information, for efficiently removing the font, concurrently with the generation of the PDF document; a step for storing the PDF document and the font-removal support information in association with each other; and a step for removing the font from the PDF document based on the font-removal support information, depending on a distribution destination, before distributing the PDF document.

### SUMMARY

When an orderer makes a print request to an order receiver, the orderer may sometimes transmit print data that contains information not be used by the order receiver. For example, when the print data to be transmitted from the orderer to the order receiver has text font data embedded therein, if the order receiver already has the font data, the order receiver is capable of printing the print data even without the font data being embedded therein.

Such transmission of the print data from the orderer out of consideration of the data to be used by the order receiver may lead to an additional printing cost. For example, if a cloud is to be used for exchanging of files, the amount of data used may increase for the amount of the embedded font, resulting in an increase in cloud usage fee.

Aspects of non-limiting embodiments of the present disclosure relate to an information processing apparatus, an information processing system, an information processing method, and a non-transitory computer readable medium that enable the cost for printing by each order receiver to be ascertainable in view of data to be used by each order receiver.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to: acquire a specification of print data and information to be used for printing the print data by each of a plurality of order receivers; and calculate a cost for placing an order for printing the print data for each order receiver based on the acquired specification of the print data and the acquired information and present the cost.

### BRIEF DESCRIPTION OF THE DRAWINGS

An exemplary embodiment of the present disclosure will be described in detail based on the following figures, wherein:

FIG. 1 schematically illustrates the configuration of an information processing system according to this exemplary embodiment;

FIG. 2 is a block diagram illustrating a relevant part of a cloud server according to this exemplary embodiment and an electrical system of an information processing terminal provided in each printing factory;

FIG. 3 is a functional block diagram illustrating a functional configuration of a printing-industry-association system according to this exemplary embodiment;

FIG. 4 illustrates how printing factory information is acquired;

FIG. 5 illustrates an acquisition procedure for acquiring a printing factory list;

FIG. 6 illustrates a display example of the printing factory list;

FIG. 7 illustrates an example of how sorting is performed based on a printing factory filter;

FIG. 8 illustrates an example of how sorting is performed based on a cost filter;

FIG. 9 illustrates an example of how sorting is performed based on a deadline filter; and

FIG. 10 is a flowchart illustrating an example of the flow of a process performed in the printing-industry-association system according to this exemplary embodiment.

### DETAILED DESCRIPTION

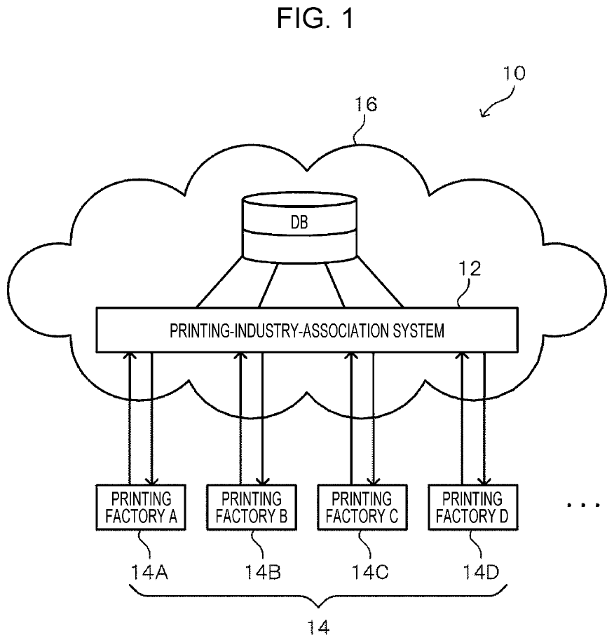

An exemplary embodiment of the present disclosure will be described in detail below with reference to the drawings. FIG. 1 schematically illustrates the configuration of an information processing system 10 according to this exemplary embodiment.

The information processing system 10 according to this exemplary embodiment includes a printing-industry-association system 12 and multiple printing factories (i.e., a printing factory A 14A, a printing factory B 14B, a printing factory C 14C, a printing factory D 14D, and so on in FIG. 1). In the following description, the printing factory A 14A, the printing factory B 14B, the printing factory C 14C, the printing factory D 14D, and so on will be referred to as “printing factories 14” if they are not to be particularly differentiated from one another.

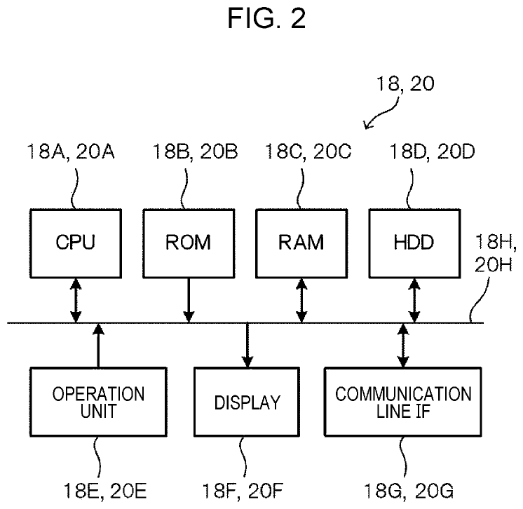

The printing-industry-association system 12 is provided in a cloud 16 and is connected to the multiple printing factories 14 via a network so as to be capable of exchanging information therewith. For example, the printing-industry-association system 12 communicates with the printing factories 14 to acquire a printing factory list indicating one or more printing factories capable of performing printing. On the other hand, the printing factories 14 transmit print settings to the printing-industry-association system 12. Specifically, each printing factory 14 is provided with an information processing terminal 20 (see FIG. 2), and the printing-industry-association system 12 and the information processing terminal 20 exchange information with each other.

Furthermore, the printing-industry-association system 12 functions as a process management system that manages a print job from an order-receiving step to an order-placement step in each connected printing factory 14, and also has a function for performing an adjustment of a print job by connecting printing factories 14 to each other. For example, if a certain printing factory 14 is not able to complete a received print job by a certain deadline, the printing-industry-association system 12 performs an adjustment to assign the print job to another printing factory 14.

Next, the configuration of a cloud server as an example of an information processing apparatus that provides the printing-industry-association system 12 as a cloud service and the configuration of an information processing terminal provided in each printing factory 14 will be described. FIG. 2 is a block diagram illustrating a relevant part of a cloud server 18 according to this exemplary embodiment and an electrical system of an information processing terminal 20 provided in each printing factory 14. Since the cloud server 18 and the information processing terminal 20 are generic computers, the cloud server 18 will be representatively described below, and a detailed description of the information processing terminal 20 will be omitted.

As shown in FIG. 2, the cloud server 18 according to this exemplary embodiment includes a central processing unit (CPU) 18A, a read-only memory (ROM) 18B, a random access memory (RAM) 18C, a hard disk drive (HDD) 18D, an operation unit 18E, a display 18F, and a communication line interface (IF) 18G. The CPU 18A controls the overall operation of the cloud server 18. The ROM 18B has preliminarily stored therein various types of control programs and various types of parameters. The RAM 18C is used as a work area when each type of program is executed by the CPU 18A. The HDD 18D has stored therein various types of data and application programs. The operation unit 18E is, for example, a keyboard and/or a mouse and is used for inputting various types of information. The display 18F is used for displaying various types of information. The communication line IF 18G is connected to various types of communication lines and exchanges various types of data with other devices connected to the communication lines. The above components of the cloud server 18 are electrically connected to one another via a system bus 18H. Although the HDD 18D is used as a storage unit in the cloud server 18 according to this exemplary embodiment, another nonvolatile storage unit, such as a flash memory, may be used as an alternative.

In the above configuration, the cloud server 18 according to this exemplary embodiment causes the CPU 18A to access the ROM 18B, the RAM 18C, and the HDD 18D, acquire various types of data via the operation unit 18E, and execute display of various types of information on the display 18F. The cloud server 18 also causes the CPU 18A to control exchanging of communication data via the communication line IF 18G.

In detail, in the cloud server 18, the CPU 18A performs a process including acquiring the specifications of print data and information to be used for printing the print data by multiple order receivers, calculating the cost for placing an order for printing the print data for each order receiver based on the acquired specifications of the print data and the acquired information, and presenting the cost for each order receiver.

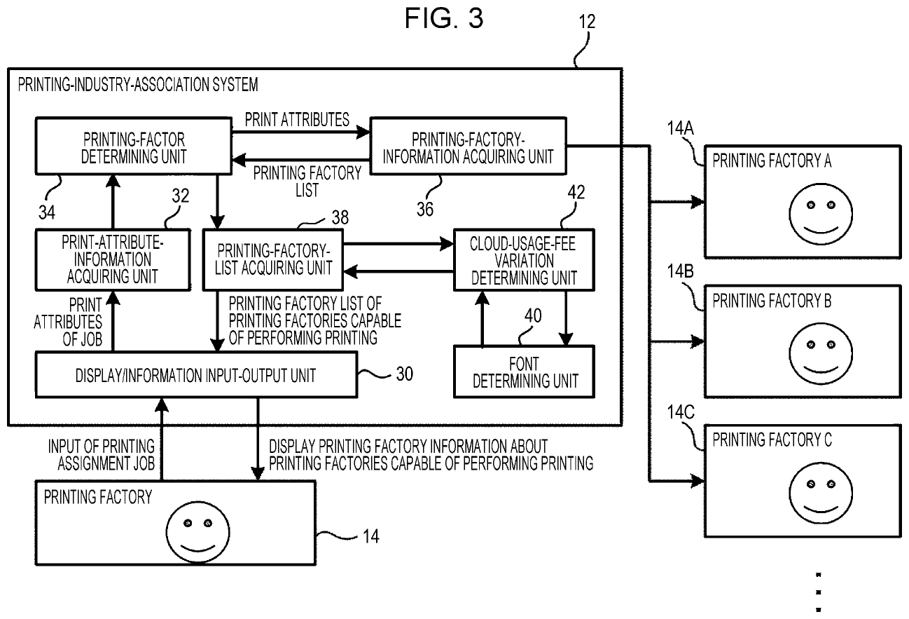

In order to perform the above process in this exemplary embodiment, the CPU 18A has functions shown in FIG. 3 implemented by executing an information processing program stored in the ROM 18B or the HDD 18D. FIG. 3 is a functional block diagram illustrating a functional configuration of the printing-industry-association system 12 according to this exemplary embodiment.

The printing-industry-association system 12 according to this exemplary embodiment functions as a display/information input-output unit 30, a print-attribute-information acquiring unit 32, a printing-factory determining unit 34, a printing-factory-information acquiring unit 36, a printing-factory-list acquiring unit 38, a font determining unit 40, and a cloud-usage-fee variation determining unit 42.

The display/information input-output unit 30 receives an input of an assigned job and job information from a user making a request for printing to a printing factory 14. The job information contains the specifications of print data and information to be used for printing the print data by multiple order receivers. The display/information input-output unit 30 also performs a process for displaying printing factories capable of performing printing. The term “job” refers to a process or a collection of processes to be executed by a printing factory 14 or a cloud service for executing printing based on print data.

The print-attribute-information acquiring unit 32 acquires print attributes from the job information input to the display/information input-output unit 30. Examples of the print attributes to be acquired include a sheet type, a sheet size, a toner, a font, and a finisher. Of these print attributes, the font corresponds to an example of the information to be used for printing the print data by each order receiver. The print attributes other than the font correspond to an example of the specifications of the print data.

The printing-factory determining unit 34 determines one or more printing factories holding the print attributes to be used for printing. For example, the print attributes to be used for printing are transmitted to the printing-factory-information acquiring unit 36, so that a corresponding printing factory list is received from the printing-factory-information acquiring unit 36.

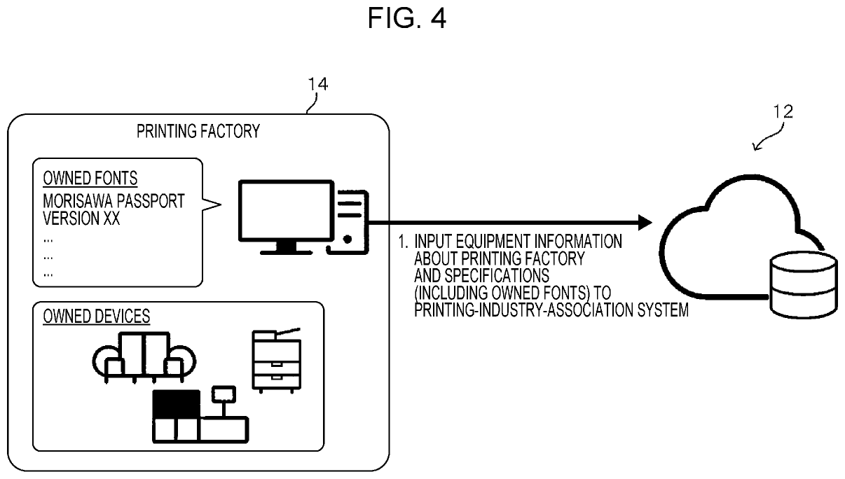

The printing-factory-information acquiring unit 36 acquires various types of printing-related information from each printing factory 14. In detail, as shown in FIG. 4, equipment information about the printing factory 14 and printing factory information, such as specifications including owned fonts, may be acquired from the printing factory 14 and be stored in a database in the printing-industry-association system 12. For example, the printing-factory-information acquiring unit 36 acquires print attributes that each printing factory 14 is capable of handling, extracts printing factories 14 corresponding to the print attributes, to be used for printing, transmitted from the printing-factory determining unit 34, and generates a printing factory list. The generated printing factory list includes, for example, deadlines and printing costs, and is transmitted to the printing-factory determining unit 34.

The printing-factory-list acquiring unit 38 acquires the printing factory list generated by the printing-factory-information acquiring unit 36, generates a printing factory list that includes variations in cloud usage fee and printing costs, and outputs the printing factory list to the display/information input-output unit 30.

The font determining unit 40 determines whether each printing factory 14 in the printing factory list holds font data, and outputs the determination result to the cloud-usage-fee variation determining unit 42.

The cloud-usage-fee variation determining unit 42 determines variations in cloud usage fee based on the determination result obtained by the font determining unit 40, and outputs the determination result to the printing-factory-list acquiring unit 38.

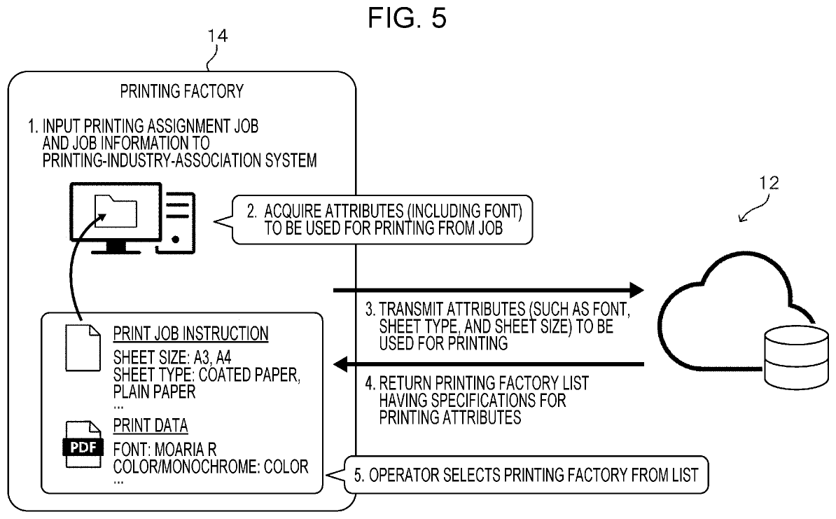

A specific example of an acquisition procedure for acquiring the printing factory list will now be described with reference to FIG. 5. FIG. 5 illustrates the acquisition procedure for acquiring the printing factory list.

First, process “1.” involves inputting a printing assignment job to the printing-industry-association system 12. For example, a print job instruction including print attributes, such as a sheet size and a sheet type, and print data including print attributes, such as a font and color information, are input.

Process “2.” involves the print-attribute-information acquiring unit 32 acquiring attributes, including the font, to be used for printing from the job.

Process “3.” involves the printing-factory determining unit 34 transmitting print attributes to be used for printing, such as the font, the sheet type, and the sheet type, to the printing-factory-information acquiring unit 36.

Process “4.” involves the printing-factory-list acquiring unit 38 returning a printing factory list having the specifications for printing the attributes to the display/information input-output unit 30 where the printing factory list is presented.

Process “5.” involves an operator selecting a printing factory from the printing factory list.

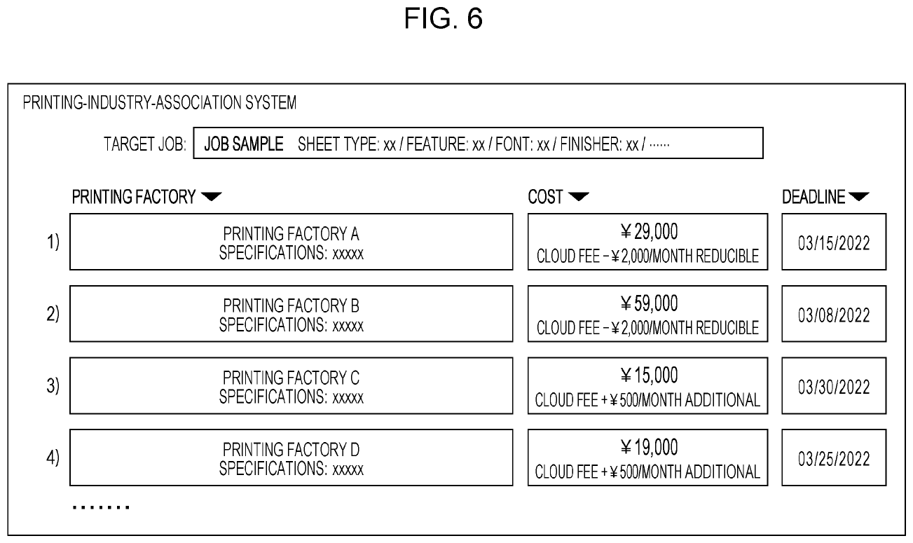

Next, a specific display example of the printing factory list displayed by the display/information input-output unit 30 will be described. FIG. 6 illustrates the display example of the printing factory list.

The printing factory list displayed in the example in FIG. 6 indicates printing factories 14 capable of outputting a target job together with the specifications of each printing factory 14. Since the cost and the deadline are inclusively displayed for each printing factory 14, it is possible to compare the costs and the deadlines. In the example in FIG. 6, a cloud usage fee is to be reduced for each of the printing factory A 14A and the printing factory B 14B, whereas a cloud usage fee is to be charged by each of the printing factory C 14C and the printing factory D 14D. The cost and the deadline vary depending on the printing factory 14 due to differences in cost and deadline caused by various factors. Examples of factors not directly related to a received order include the number of owned printers, the volume of receivable orders, land cost, and labor cost. Examples of factors directly related to a received order include the time of year (such as an off season or a busy season), the support system, the equipment used, and delivery cost.

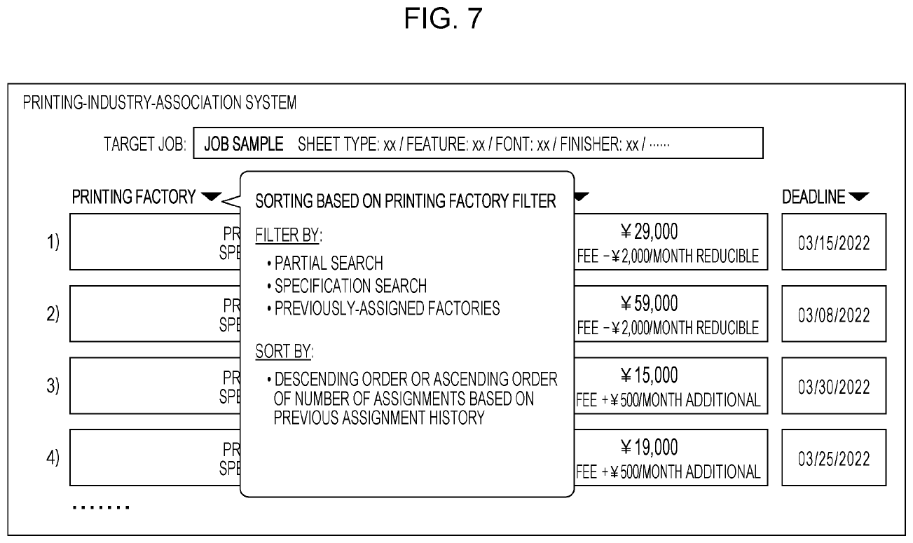

As shown in FIG. 7, the printing factory list may be sorted based on a printing factory filter. Examples of the filter include a partial search, a specification search, and previously-assigned printing factories 14. The sorting may be performed in descending order or ascending order of the number of assignments based on a previous assignment history.

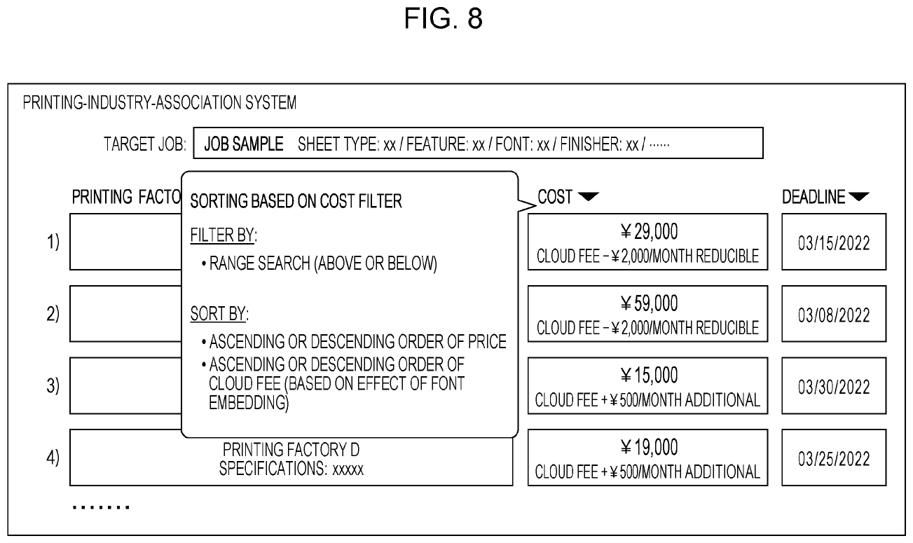

As shown in FIG. 8, the printing factory list may be sorted based on a cost filter. An example of the filter includes a range search (below or above). The sorting may be performed in ascending order or descending order of price, in ascending or descending order of the cloud fee, or in descending order based on the effect of font embedding.

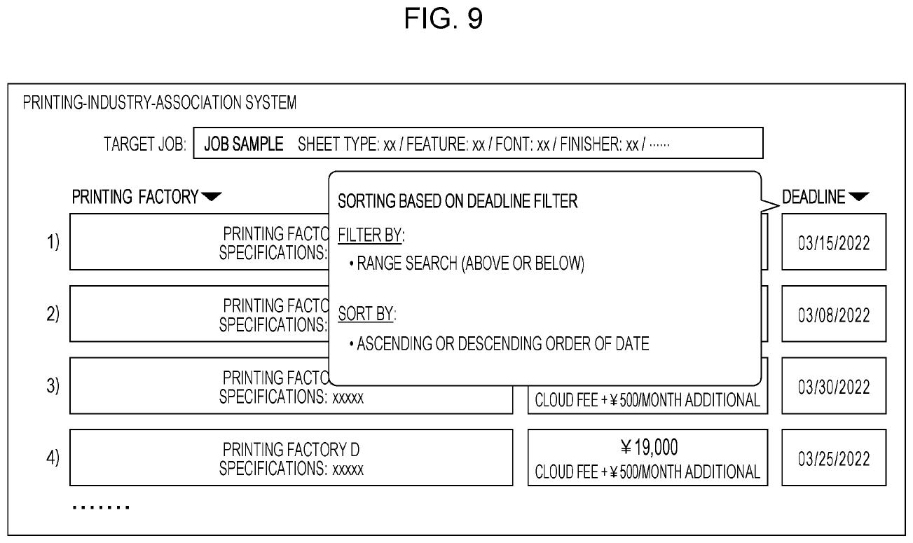

As shown in FIG. 9, the printing factory list may be sorted based on a deadline filter. An example of the filter includes a range search (below or above). The sorting may be performed in ascending order or descending order of date.

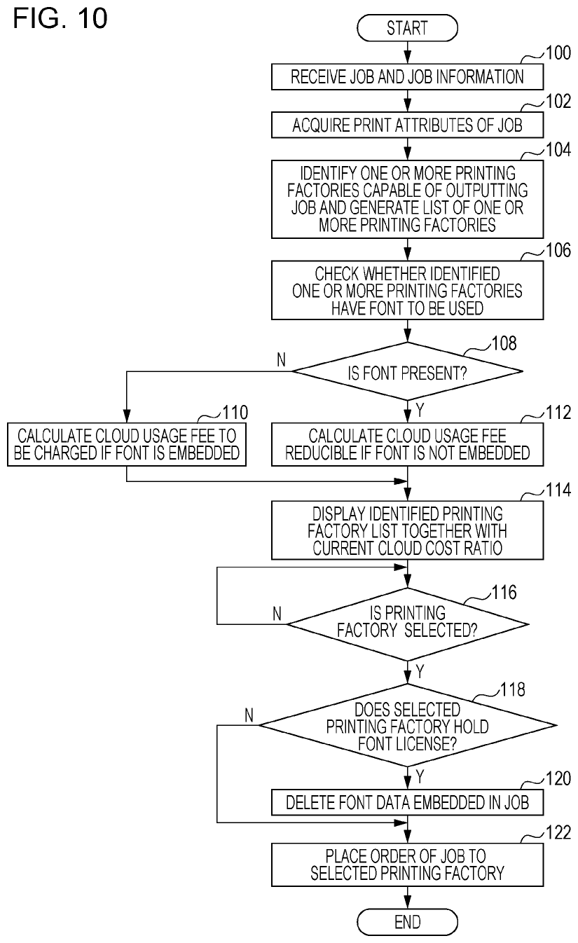

Next, a specific process performed in the printing-industry-association system 12 according to this exemplary embodiment having the above-described configuration will be described. FIG. 10 is a flowchart illustrating an example of the flow of the process performed in the printing-industry-association system 12 according to this exemplary embodiment. For example, the process in FIG. 10 commences when a client inputs a job and job information to the printing-industry-association system 12.

In step 100, the CPU 18A receives the job and the job information and proceeds to step 102. Specifically, the display/information input-output unit 30 receives an input of a printing assignment job and job information from a user making a request.

In step 102, the CPU 18A acquires print attributes of the job and proceeds to step 104. Specifically, the print attributes are acquired from the job information input to the display/information input-output unit 30.

In step 104, the CPU 18A identifies one or more printing factories 14 that are capable of outputting the job, generates a list of the one or more printing factories 14, and proceeds to step 106. Specifically, the printing-factory-information acquiring unit 36 acquires various types of printing-related information from each printing factory 14 and generates a printing factory list.

In step 106, the CPU 18A checks whether the identified one or more printing factories 14 have the font to be used, and proceeds to step 108. Specifically, the font determining unit 40 determines whether or not each printing factory 14 in the printing factory list has the font.

In step 108, the CPU 18A determines whether or not the font is present. If a negative determination result is obtained, the CPU 18A proceeds to step 110. If a positive determination result is obtained, the CPU 18A proceeds to step 112.

In step 110, the CPU 18A calculates a cloud usage fee to be charged in a case where the font is embedded, and proceeds to step 114. Specifically, the cloud-usage-fee variation determining unit 42 calculates a cloud usage fee to be charged in a case where font data is embedded.

In contrast, in step 112, the CPU 18A calculates a cloud usage fee reducible in a case where the font is not embedded, and proceeds to step 114. Specifically, the cloud-usage-fee variation determining unit 42 calculates a cloud usage fee reducible in a case where font data is not embedded.

In step 114, the CPU 18A displays the identified printing factory list together with a current cloud cost ratio, and proceeds to step 116. For example, as shown in FIG. 6, the display/information input-output unit 30 displays a printing factory list indicating one or more printing factories capable of outputting a target job together with the specifications of each printing factory 14.

In step 116, the CPU 18A determines whether or not a printing factory is selected. This determination is performed based on whether or not the display/information input-output unit 30 has received selection of a printing factory. The CPU 18A waits until a positive determination result is obtained, and then proceeds to step 118.

In step 118, the CPU 18A determines whether or not the selected printing factory 14 holds a font license. If the selected printing factory 14 holds the font license and a positive determination result is obtained, the CPU 18A proceeds to step 120. If a negative determination result is obtained, the CPU 18A proceeds to step 122.

In step 120, the CPU 18A deletes the font data embedded in the job and proceeds to step 122.

In step 122, the CPU 18A transmits the job and the job information to the selected printing factory 14 to place an order of the job, and ends the process.

Although the above exemplary embodiment relates to an example where the cost varies due to variations in the cloud usage fee depending on whether or not a font is present, the factor for the variations in the cost is not limited to this. For example, in a case where information, such as print data, already transmitted to a printing factory 14 is to be used again, the transmitted information does not have to be retransmitted. Therefore, the cost may vary depending on whether or not the transmitted information is to be used again.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The process performed by each unit of the information processing system 10 according to the above exemplary embodiment may be a process performed by software, a process performed by hardware, or a process performed by a combination of the two.

Furthermore, the process performed by each unit of the information processing system 10 may be distributed by being stored as a program in a storage medium.

The exemplary embodiment of the present disclosure is not limited to that described above, and various modifications are permissible so long as they do not depart from the gist of the exemplary embodiment of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus comprising:
a processor configured to:
   acquire a specification of print data and information to be used for printing the print data by each of a plurality of order receivers; and
   calculate a cost for placing an order for printing the print data for each order receiver based on the acquired specification of the print data and the acquired information and present the cost.
      (((2)))

The information processing apparatus according to (((1))), wherein the processor is configured to receive an order-receiver selection result and place the order to a selected one of the order receivers.

(((3)))

The information processing apparatus according to (((2))), wherein the processor is configured to delete the information from the print data and place the order if the information is embedded in the print data and the selected order receiver is not to embed the information.

(((4)))

The information processing apparatus according to any one of (((1))) to (((3))), wherein the processor is configured to delete font data as the information and place the order.

(((5)))

The information processing apparatus according to any one of (((1))) to (((4))), wherein the processor is configured to further present the cost and a deadline for each order receiver.

(((6)))

The information processing apparatus according to (((5))), wherein the processor is configured to perform sorting and presentation by using the order receiver as a filter.

(((7)))

The information processing apparatus according to (((5))), wherein the processor is configured to perform sorting and presentation by using the cost as a filter.

(((8)))

The information processing apparatus according to (((5))), wherein the processor is configured to perform sorting and presentation by using the deadline as a filter.

(((9)))

An information processing system comprising:
the information processing apparatus according to any one of (((1))) to (((8))); and
an information processing terminal that transmits the specification of the print data and the information to the information processing apparatus and that receives the cost calculated for each order receiver.
   (((10)))

An information processing program causing a computer to execute a process, the process comprising:
acquiring a specification of print data and information to be used for printing the print data by each of a plurality of order receivers; and
calculating a cost for placing an order for printing the print data for each order receiver based on the acquired specification of the print data and the acquired information and presenting the cost.

What is claimed is:

1. An information processing apparatus comprising:
a processor configured to:
acquire a specification of print data and information to be used for printing the print data by each of a plurality of order receivers; and
calculate a cost for placing an order for printing the print data for each order receiver based on the acquired specification of the print data and the acquired information and present the cost.

2. The information processing apparatus according to claim 1, wherein the processor is configured to receive an order-receiver selection result and place the order to a selected one of the order receivers.

3. The information processing apparatus according to claim 2, wherein the processor is configured to delete the information from the print data and place the order if the information is embedded in the print data and the selected order receiver is not to embed the information.

4. The information processing apparatus according to claim 3, wherein the processor is configured to delete font data as the information and place the order.

5. The information processing apparatus according to claim 1, wherein the processor is configured to further present the cost and a deadline for each order receiver.

6. The information processing apparatus according to claim 5, wherein the processor is configured to perform sorting and presentation by using the order receiver as a filter.

7. The information processing apparatus according to claim 5, wherein the processor is configured to perform sorting and presentation by using the cost as a filter.

8. The information processing apparatus according to claim 5, wherein the processor is configured to perform sorting and presentation by using the deadline as a filter.

9. An information processing system comprising:
the information processing apparatus according to claim 1; and
an information processing terminal that transmits the specification of the print data and the information to the information processing apparatus and that receives the cost calculated for each order receiver.

10. A non-transitory computer readable medium storing a program causing a computer to execute a process for processing information, the process comprising:
acquiring a specification of print data and information to be used for printing the print data by each of a plurality of order receivers; and
calculating a cost for placing an order for printing the print data for each order receiver based on the acquired specification of the print data and the acquired information and presenting the cost.

11. An information processing method comprising:
acquiring a specification of print data and information to be used for printing the print data by each of a plurality of order receivers; and
calculating a cost for placing an order for printing the print data for each order receiver based on the acquired specification of the print data and the acquired information and presenting the cost.
